(19) United States
(12) Patent Application Publication
(10) Pub. No.: US 2024/0361803 A1
(43) Pub. Date: Oct. 31, 2024

(54) CRADLES FOR MOBILE DEVICES WITH AT LEAST ONE HEATING ELEMENT FOR CONTACTS AND METHODS OF MAKING AND USING

(71) Applicant: National Products, Inc., Seattle, WA (US)

(72) Inventors: Jeffrey D. Carnevali, Seattle, WA (US); Scott Anderson, Seattle, WA (US)

(21) Appl. No.: 18/141,291

(22) Filed: Apr. 28, 2023

(51) Int. Cl. G06F 1/16; G05D 23/24; H04M 1/04

(52) U.S. Cl. CPC G06F 1/1632; G05D 23/24; H04M 1/04

(57) ABSTRACT

A cradle for a mobile device includes a cradle body; a plurality of biasing contacts extending from the cradle body and configured for making contact with contacts on the mobile device or case; and at least one heating element disposed within the cradle body and configured, in operation, to heat the biasing contacts.

### FIELD

The present invention is directed to cradles for a mobile device. The present invention is also directed to a cradle for a mobile device that includes at least one heating element for heating contacts of the cradle.

### BACKGROUND

Mobile devices, such as smartphones, cellular or mobile phones, tablets, personal data assistants, and other portable devices, are now ubiquitous. Cradles can be used to protect the mobile device and to mount the mobile device onto a surface or object.

### BRIEF SUMMARY

One embodiment is a cradle for a mobile device. The cradle includes a cradle body; a plurality of biasing contacts extending from the cradle body and configured for making contact with contacts on the mobile device or case; and at least one heating element disposed within the cradle body and configured, in operation, to heat the biasing contacts.

In at least some embodiments, the cradle further includes electronic circuitry disposed in the cradle body and coupled to the at least one heating element and configured for directing operation of the at least one heating element. In at least some embodiments, the cradle further includes a temperature sensor disposed in the cradle body, coupled to the electronic circuitry, and configured to measure or estimate a cradle or ambient temperature. In at least some embodiments, the temperature sensor includes a thermistor.

In at least some embodiments, at least one of the biasing contacts includes a housing and a pin partially disposed within the housing and configured to move up and down within the housing. In at least some embodiments, at least one of biasing contacts includes a pogo pin. In at least some embodiments, the cradle further includes a substrate disposed within the cradle body, wherein each of the biasing contacts is coupled to the substate. In at least some embodiments, the substrate includes a printed circuit board.

In at least some embodiments, the cradle body includes a cradle base, a bottom device receiver coupled to the cradle base and configured to retain a bottom portion of a mobile device or a case containing the mobile device loaded into the cradle; and a top cup coupled to the cradle base and configured to retain a top portion of the mobile device or the case containing the mobile device loaded into the cradle. In at least some embodiments, the bottom device receiver includes a cover coupleable to a remainder of the bottom device receiver and configured to allow access to a cavity defined within the bottom device receiver. In at least some embodiments, each of the biasing contacts is partially disposed within the cavity and extends out of the bottom device receiver.

In at least some embodiments, the cradle further includes a connector cord extending from the cradle body and electrically coupled to the contacts.

Another embodiment is a system that includes any of the cradles described above and a mobile device insertable into the cradle. In at least some embodiments, the cradle is configured for operation of the at least one heating element by the mobile device.

Yet another embodiment is a method for using a cradle for a mobile device. The method includes providing any of the cradles described above and heating the biasing contacts using the at least one heating element.

In at least some embodiments, heating the biasing contacts includes operating the at least one heating element using electronic circuitry disposed within the cradle body. In at least some embodiments, heating the biasing contacts includes measuring or estimating a cradle or ambient temperature using a temperature sensor disposed within the cradle body and providing the measured or estimated temperature to the electronic circuitry for operating the at least one heating element. In at least some embodiments, operating the at least one heating element includes turning on the at least one heating element when the measured or estimated temperature falls below a threshold temperature. In at least some embodiments, operating the at least one heating element includes turning off the at least one heating element when the measured or estimated temperature exceeds a threshold temperature.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic perspective side view of one embodiment of a cradle for a mobile device, according to the invention;

FIG. 2 is a schematic perspective size view of the cradle of FIG. 1 with a cover of a bottom device receiver removed, according to the invention;

FIG. 3 is a schematic perspective cross-sectional view of a portion of the cradle of FIG. 1 including the bottom device receiver, according to the invention; and

FIG. 4 is a schematic perspective side view of contacts and heating elements of the cradle of FIG. 1, according to the invention.

### DETAILED DESCRIPTION

The present invention is directed to cradles for a mobile device. The present invention is also directed to a cradle for a mobile device that includes at least one heating element for heating contacts of the cradle.

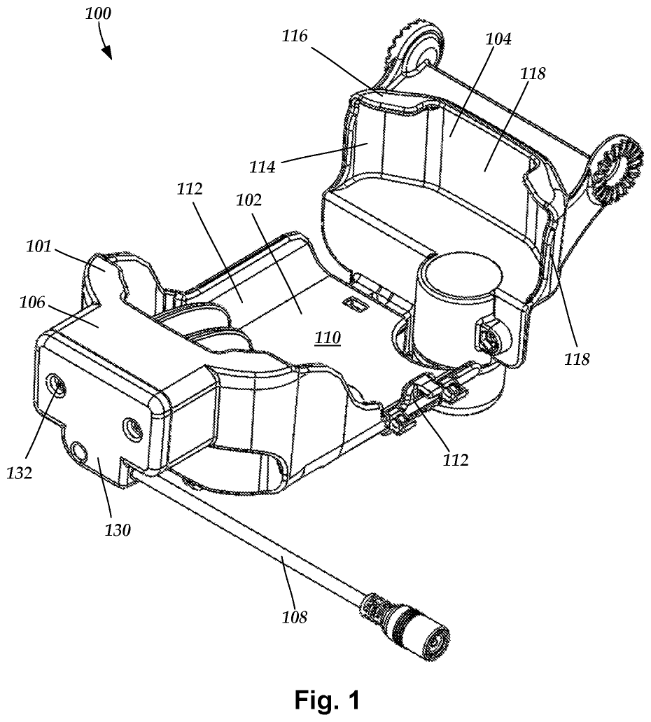

FIG. 1 illustrates one embodiment of a cradle 100 for a mobile device, such as a cellular or mobile phone, a smartphone, a tablet, a personal data assistant, or any other suitable mobile device. The cradle 100 includes a cradle body 101. The cradle body can include different arrangements of components, such as, for example, a cradle base 102, a top cup 104 for receiving a top portion of the mobile device, and a bottom device receiver 106 coupled to, or part of, the cradle base 102, as illustrated in FIG. 1. The 100 cradle may also include an optional connector cord 108 extending from the cradle body 101 such as, for example, from the bottom device receiver 106. Other cradles may have more or fewer components. For example, a cradle may not include a top cup 104. For purposes of illustration, the following discussion uses the cradle 100 of FIG. 1 as an example, but it will be understood that other cradles can replace cradle 100.

The cradle base 102 includes a back plate 110 and optional opposing sidewalls 112. In at least some embodiments, the optional opposing sidewalls 112 of the cradle base 102 facilitate retention of the mobile device in the cradle 100 in combination with one or more of the top cup 104 or bottom device receiver 106. In at least some embodiments, an optional mount can be coupled, or coupleable, to the cradle 100. Non-limiting examples of mounts can be found at U.S. Pat. Nos. 5,845,885; 6,561,476; 7,320,50; 7,997,554; 8,454,178; 8,505,861; 9,831,904; RE42,060; RE42,581; and RE43,806, all of which are incorporated herein by reference in their entireties.

The top cup 104 is coupled to the cradle base 102. The top cup 104 includes a cup portion 114 with a top wall 116 and sidewalls 118 extending from the top wall to engage two or more of the front, back, or side surfaces of the top portion of the mobile device in order to retain the mobile device in the cradle. In at least some embodiments, the top cup 104 can move relative to the cradle base 102. Non-limiting examples of cradles having a top cup that can move relative to the cradle base can be found in U.S. Pat. Nos. 11,076,032 and 11,489,350 and U.S. Patent Application Publication No. 2023/0045485, all of which are incorporated herein by reference in their entireties.

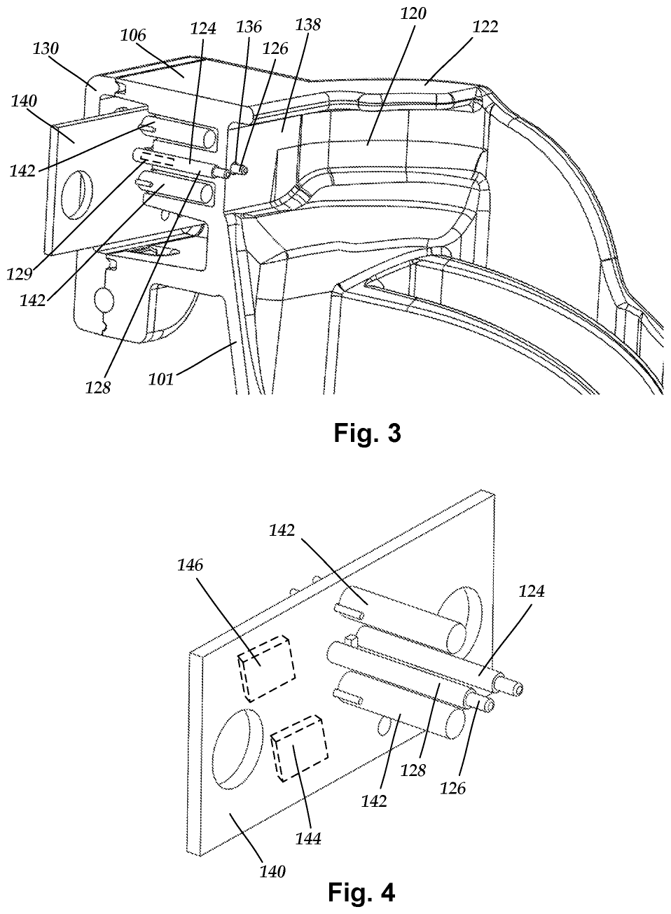

The bottom device receiver 106 is attached to the cradle base 102 and may be integrally formed with the cradle base or may be detachable from the cradle base. FIG. 3 illustrates one embodiment of the bottom device receiver 106 which includes a recess 120 surrounded by a rim 122 that may facilitate retention of the mobile device in the cradle 100. The bottom device receiver 106 includes one or more contacts 124. In at least some embodiments, the recess 120, rim 122, and contacts 124 form a female connector. Any arrangement of the contacts 124 can be used including, but not limited to, an arrangement of the contacts in one or more rows. When the arrangement includes two or more rows, the contacts in the rows can be aligned or staggered. In other embodiments of the cradle 100, the contacts 124 can be positioned anywhere in or on the cradle body 101 such as, for example, in or on the cradle base 102 or the top cup 104.

The contacts 124 make electrical contact with contacts on the mobile device or a case disposed on the mobile device when the mobile device is inserted into the cradle 100. Examples of cases with contacts include, but are not limited to, the cases, covers, or skins described in U.S. Pat. Nos. 9,195,279; 9,331,444; 9,529,387; 9,602,639; 9,632,535; 9,706,026; 10,050,658; 10,054,984; 10,389,399; 10,454,515; and 10,630,334 and U.S. patent application Ser. Nos. 16/853,544 and 16/866,156, all of which are incorporated herein by reference in their entireties. The contacts 124 in the cradle 100 can be used to transfer power to the mobile device from a power source, transfer data between the mobile device and a data source, or any combination thereof. In at least some embodiments, the shape of the recess 120 and rim 122 can be complementary to a male structure of a case (see, for example, the cases, covers, or skins in the references cited above) or mobile device.

The cradle 100 can include an optional connector cord 108 that is electrically coupled to the contacts 124 and coupleable to a power source, data source, or any combination thereof. The optional connector cord 108 can be hardwired to a device or can include any type of connector 146, as illustrated in FIG. 1, including, but not limited to, any type of USB connector, a Lightning connector, or the like or any combination thereof. Alternatively, instead of a connector cord, the bottom device receiver 106 can include a connector (or jack), such as a female or male connector. A connector cord can be coupled to this connector with the connector cord attached or attachable to a power source, a data source, or any combination thereof. The connector can be any type of connector including, but not limited to, any type of USB connector, a Lightning connector, or the like or any combination thereof.

The contacts 124 are pogo pins or other biasing contacts that can move up or down relative to the cradle body 101 such as, for example, the bottom device receiver 106. In at least some embodiments, each of the contacts 124 includes a pin 126 and a housing 128 with the pin partially disposed in the housing and movable within the housing. In at least some embodiments, the contacts 124 include a spring 129 or other biasing mechanism within the housing 128 which bias the pin 126 to extend out of the housing 128 while retaining a portion of the pin within the housing.

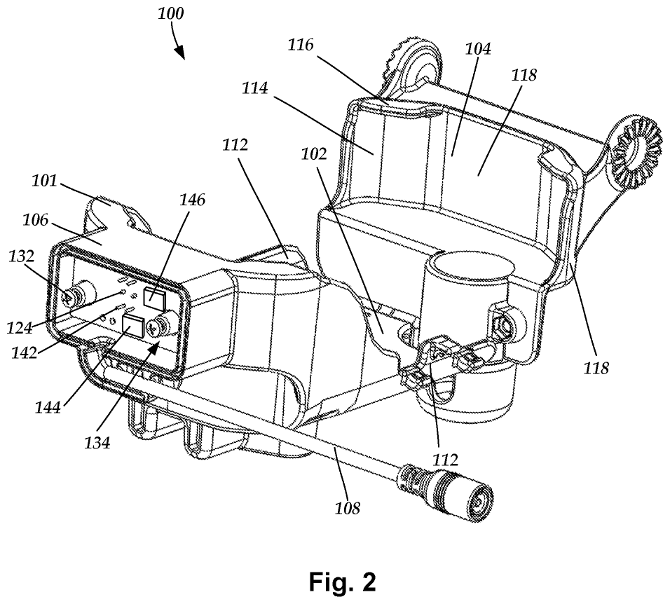

FIG. 2 illustrates the cradle 100 with a cover 130 (FIG. 1) of the bottom device receiver 106 removed. The cover 130 can be attached to the remainder of the bottom device receiver 106 using one or more fasteners 132, as illustrated in FIG. 1. As an example, the contacts 124 (i.e., pogo pins) are disposed in the interior cavity 134 of the bottom device receiver 106, as illustrated in FIG. 2, (or in an interior cavity of any other portion of the cradle body 101) and extend out of openings 136 in a floor 138 of the bottom device receiver 106 as illustrated in FIG. 3. In at least some embodiments, the contacts 124 are coupled to a substrate 140 such as a printed circuit board (PCB).

In at least some instances, pogo pins (e.g., contacts 124) can freeze when exposed to cold weather, particularly when water is present. Freezing may prevent or hinder the contacts 124 (e.g., pogo pins) moving up or down (e.g., the pins 126 moving within the housings 128). This may result in difficulties in making contact with the contacts on the mobile device or case because the pogo pins do not move upward or may hinder insertion of the mobile device into the cradle because the pogo pins do not move downward.

To address freezing or other issues, the cradle 100 can include at least one heating element 142 to warm the contacts 124 (e.g., pogo pins), as illustrated in FIGS. 3 and 4. In at least some embodiments, the heating element(s) 142 is/are disposed near (for example, within 1, 2, 5, or 10 mm of) the contacts 124. Any suitable heating element 142 can be used including, for example, resistive heating elements (e.g., resistors) or the like. A cradle 100 can include any suitable number of heating elements 142 including one, two, three, four, five, six, or more heating elements. In at least some embodiments, the number of heating elements 142 may be selected based on the number of contacts 124. When multiple heating elements 142 are present, the heating elements can be disposed in any suitable arrangement relative to the contacts 124. As an example, two or more of the heating elements 142 can be disposed opposite each other with the contacts 124 between the heating elements, as illustrated in FIGS. 3 and 4. Embodiments with more heating elements 142 may use some or all of the heating elements form a perimeter around the contacts 124.

In at least some embodiments, the cradle 100 can include electronic circuitry 144 coupled to the heating element(s) 142 for operation of the heating element(s). In at least some embodiments, the electronic circuitry 144 includes a relay or other switching mechanism for operation of (e.g., turning on or off) the heating element(s). In at least some embodiments, the electronic circuitry 144 includes an integrated circuit (IC) and associated circuitry for operation of the heating element(s), optionally, in conjunction with the relay. Such operation can include one or more of the following: turning the heating element(s) on or off, selecting which heating elements are on, increasing or decreasing the heat generated by the heating element(s), or any combination thereof.

In at least some embodiments, the cradle 100 can include a temperature sensor 146, such as a thermistor or any other suitable temperature sensor, which can be used to measure or estimate the temperature of the cradle or the ambient temperature. In at least some embodiments, the electronic circuitry 144, temperature sensor 146, or both are disposed on the substrate 140.

In at least some embodiments, the temperature sensor 146 is coupled to the electronic circuitry 144 to control the heating element(s) 142 based on the temperature measured or estimated using the temperature sensor. In at least some embodiments, the heating element(s) 142 can be controlled (e.g., turned on or off) directly using the temperature sensor 146 and a relay or other switching mechanism as the temperature falls below a threshold temperature or exceeds the threshold temperature, respectively.

In at least some embodiments, instead of electronic circuitry 144 or a temperature sensor 146 in the cradle 100, operation of the heating element(s) may be controlled by the mobile device or another device (for example, a device coupled to the cradle via the connector cord 108 or wirelessly coupled to the cradle or mobile device) or using a temperature measurement or estimation obtained from the mobile device or other device.

The inclusion of heating elements 142, electronic circuitry 144, and temperature sensor 146 (or any selection of these items) can be incorporated into any other suitable cradle with biasing contacts 142, such as pogo pins. Non-limiting examples of other cradles that can incorporate any of these items are described in U.S. Pat. Nos. 9,831,904; 11,029,731; 11,076,032; 11,277,506; and 11,489,350 and U.S. Patent Application Publication No. 2023/0045485, all of which are incorporated herein by reference in their entireties.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A cradle for a mobile device, the cradle comprising:
a cradle body;
a plurality of biasing contacts extending from the cradle body and configured for making contact with contacts on the mobile device or case; and
at least one heating element disposed within the cradle body and configured, in operation, to heat the biasing contacts.

2. The cradle of claim 1, further comprising electronic circuitry disposed in the cradle body and coupled to the at least one heating element and configured for directing operation of the at least one heating element.

3. The cradle of claim 2, further comprising a temperature sensor disposed in the cradle body, coupled to the electronic circuitry, and configured to measure or estimate a cradle or ambient temperature.

4. The cradle of claim 3, wherein the temperature sensor comprises a thermistor.

5. The cradle of claim 1, wherein at least one of the biasing contacts comprises a housing and a pin partially disposed within the housing and configured to move up and down within the housing.

6. The cradle of claim 1, wherein at least one of biasing contacts comprises a pogo pin.

7. The cradle of claim 1, further comprising a substrate disposed within the cradle body, wherein each of the biasing contacts is coupled to the substate.

8. The cradle of claim 7, wherein the substrate comprises a printed circuit board.

9. The cradle of claim 1, wherein the cradle body comprises a cradle base, a bottom device receiver coupled to the cradle base and configured to retain a bottom portion of a mobile device or a case containing the mobile device loaded into the cradle; and a top cup coupled to the cradle base and configured to retain a top portion of the mobile device or the case containing the mobile device loaded into the cradle.

10. The cradle of claim 9, wherein the bottom device receiver comprises a cover coupleable to a remainder of the bottom device receiver and configured to allow access to a cavity defined within the bottom device receiver.

11. The cradle of claim 10, wherein each of the biasing contacts is partially disposed within the cavity and extends out of the bottom device receiver.

12. The cradle of claim 1, further comprising a connector cord extending from the cradle body and electrically coupled to the contacts.

13. A system, comprising:
the cradle of claim 1; and
a mobile device insertable into the cradle.

14. The system of claim 13, wherein the cradle is configured for operation of the at least one heating element by the mobile device.

15. A method for using a cradle for a mobile device, the method comprising:
providing the cradle of claim 1; and
heating the biasing contacts using the at least one heating element.

16. The method of claim 15, wherein heating the biasing contacts comprises operating the at least one heating element using electronic circuitry disposed within the cradle body.

17. The method of claim 16, wherein heating the biasing contacts comprises measuring or estimating a cradle or ambient temperature using a temperature sensor disposed within the cradle body and providing the measured or estimated temperature to the electronic circuitry for operating the at least one heating element.

18. The method of claim 17, wherein operating the at least one heating element comprises turning on the at least one heating element when the measured or estimated temperature falls below a threshold temperature.

19. The method of claim 18, wherein operating the at least one heating element comprises turning off the at least one heating element when the measured or estimated temperature exceeds a threshold temperature.

20. The method of claim 15, wherein at least one of the contacts is a pogo pin.
